(19) United States
(12) Patent Application Publication
(10) Pub. No.: US 2011/0168083 A1
(43) Pub. Date: Jul. 14, 2011

(54) CNT-INFUSED CERAMIC FIBER MATERIALS AND PROCESS THEREFOR

(75) Inventors: Tushar K. SHAH, Columbia, MD (US); Slade H. GARDNER, Fort Worth, TX (US); Mark R. ALBERDING, Glen Arm, MD (US); Harry C. MALECKI, Abingdon, MD (US)

(73) Assignee: Lockheed Martin Corporation, Bethesda, MD (US)

(21) Appl. No.: 12/714,379

(22) Filed: Feb. 26, 2010

Related U.S. Application Data
(63) Continuation of application No. 12/611,103, filed on Nov. 2, 2009.
Application No. 12/611,103 is a continuation-in-part of application No. 11/619,327, filed on Jan. 3, 2007.
(60) Provisional application No. 61/182,153, filed on May 29, 2009.
(60) Provisional application No. 61/169,055, filed on Apr. 14, 2009.
(60) Provisional application No. 61/168,516, filed on Apr. 10, 2009.
(60) Provisional application No. 61/157,096, filed on Mar. 3, 2009.
(60) Provisional application No. 61/155,935, filed on Feb. 27, 2009.

(51) Int. Cl. B05C 9/08; B05C 11/00; B05C 13/00; B82Y 30/00; B82Y 40/00

(52) U.S. Cl. 118/33; 118/75; 118/72; 977/750; 977/752; 977/773; 977/847; 977/843

(57) ABSTRACT

A composition includes a carbon nanotube (CNT)-infused ceramic fiber material, wherein the CNT-infused ceramic fiber material includes: a ceramic fiber material of spoolable dimensions; and carbon nanotubes (CNTs) bonded to the ceramic fiber material. The CNTs are uniform in length and uniform in distribution. A continuous CNT infusion process includes (a) disposing a carbon-nanotube forming catalyst on a surface of a ceramic fiber material of spoolable dimensions; and (b) synthesizing carbon nanotubes on the ceramic fiber material, thereby forming a carbon nanotube-infused ceramic fiber material.

### STATEMENT OF RELATED APPLICATIONS

This application is a continuation of U.S. patent application Ser. No. 12/611,103, filed Nov. 2, 2009, which is a continuation-in-part of U.S. patent application Ser. No. 11/619,327 filed Jan. 3, 2007. This application claims priority to U.S. Provisional Application Nos. 61/168,516, filed Apr. 10, 2009, 61/169,055 filed Apr. 14, 2009, 61/155,935 filed Feb. 27, 2009, 61/157,096 filed Mar. 3, 2009, and 61/182,153 filed May 29, 2009, all of which are incorporated herein by reference in their entirety.

### STATEMENT REGARDING FEDERALLY SPONSORED RESEARCH OR DEVELOPMENT

Not applicable.

### FIELD OF THE INVENTION

The present invention relates to fiber materials, more specifically to ceramic fiber materials modified with carbon nanotubes.

### BACKGROUND OF THE INVENTION

Fiber materials are used for many different applications in a wide variety of industries, such as the commercial aviation, recreation, industrial and transportation industries. Commonly-used fiber materials for these and other applications include ceramic fiber, cellulosic fiber, carbon fiber, metal fiber, ceramic fiber and aramid fiber, for example.

Ceramic fiber materials, in particular, are useful in thermal insulation applications, in ballistics protection, and high performance applications such jet engine turbine blades, and missile nose cones. In order to realize high fracture toughness in a ceramic composite material, there should be a strong interaction between the ceramic fiber and the matrix material. Such an interaction can be achieved through the use of fiber sizing agents.

However, most conventional sizing agents have a lower interfacial strength than the ceramic fiber material to which they are applied. As a consequence, the strength of the sizing and its ability to withstand interfacial stress ultimately determines the strength of the overall composite. Thus, using conventional sizing, the resulting composite will generally have a strength less than that of the ceramic fiber material. It would be useful to develop sizing agents and processes of coating the same on ceramic fiber materials to address some of the issues described above as well as to impart desirable characteristics to the ceramic fiber materials. The present invention satisfies this need and provides related advantages as well.

### SUMMARY OF THE INVENTION

In some aspects, embodiments disclosed herein relate to a composition that includes a carbon nanotube (CNT)-infused ceramic fiber material, wherein the CNT-infused ceramic fiber material includes: a ceramic fiber material of spoolable dimensions; and carbon nanotubes (CNTs) bonded to the ceramic fiber material. The CNTs are uniform in length and uniform in distribution.

In aspects, embodiments disclosed herein relate to a continuous CNT infusion process includes (a) disposing a carbon-nanotube forming catalyst on a surface of a ceramic fiber material of spoolable dimensions; and (b) synthesizing carbon nanotubes on the ceramic fiber material, thereby forming a carbon nanotube-infused ceramic fiber material.

### BRIEF DESCRIPTION OF THE DRAWINGS

FIG. 1 shows a transmission electron microscope (TEM) image of multi-walled carbon nanotubes harvested from CNT-infused ceramic fibers.

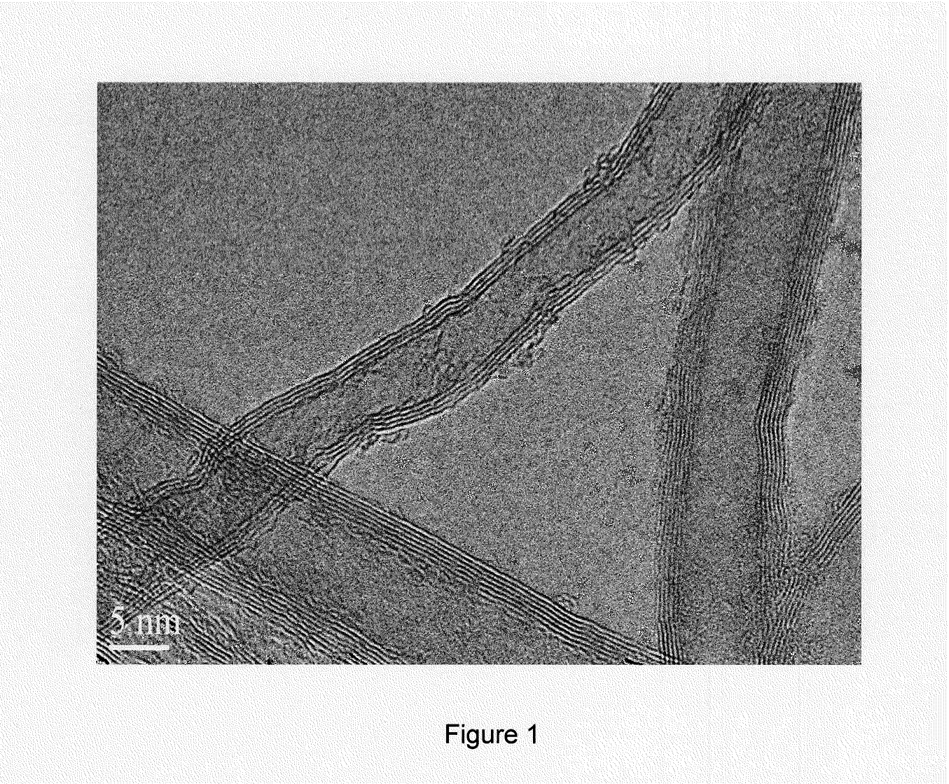

FIG. 2 shows a scanning electron microscope (SEM) image of a single alumina fiber with CNT-infusion of uniform length approaching 2 microns.

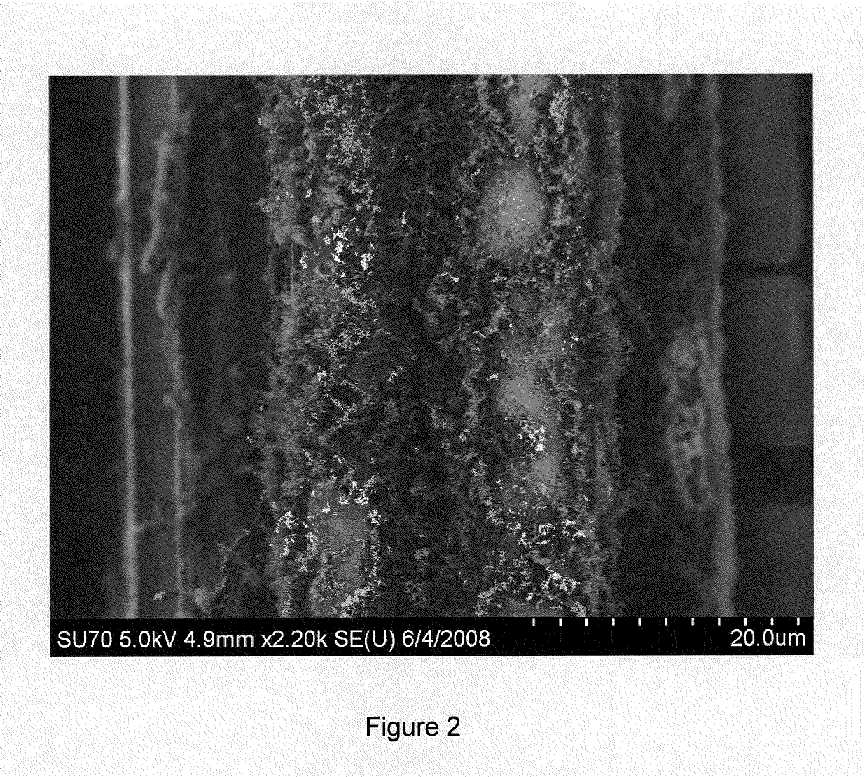

FIG. 3 shows a SEM image of multiple alumina fibers with CNT infusion of uniform density within about 10% across the roving.

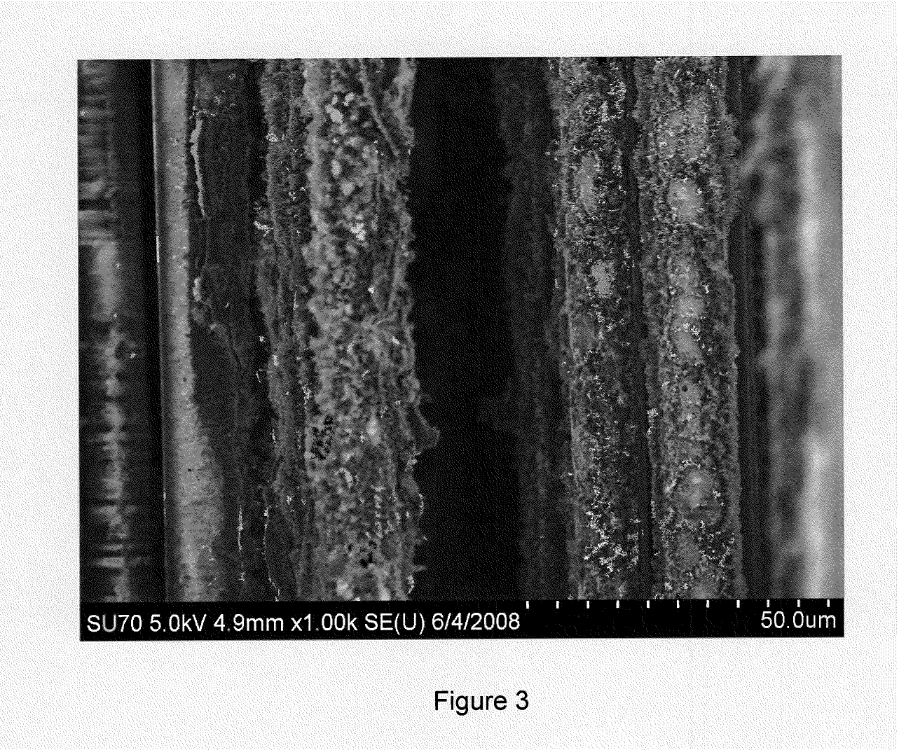

FIG. 4 shows a flow diagram for a method of forming CNT-infused ceramic fibers in accordance with some embodiments.

FIG. 5 shows a flow diagram showing a method of CNT-infusion on a ceramic fiber material in a continuous process to target thermal and electrical conductivity improvements.

FIG. 6 shows a flow diagram showing a method of CNT-infusion on a ceramic fiber material in a continuous process to target improvements in mechanical properties, including interfacial characteristics such as shear strength.

FIG. 7 shows a flow diagram for a method for CNT-infusion of ceramic fiber in a continuous process for applications requiring improved tensile strength, where the system is interfaced with subsequent resin incorporation and winding process.

### DETAILED DESCRIPTION

The present disclosure is directed, in part, to carbon nanotube-infused (“CNT-infused”) ceramic fiber materials. The infusion of CNTs to the ceramic fiber material can serve many functions including, for example, as a sizing agent to protect against damage from moisture and the like. A CNT-based sizing can also serve as an interface between a ceramic and a hydrophobic matrix material in a composite. The CNTs can also serve as one of several sizing agents coating the ceramic fiber material.

Moreover, CNTs infused on a ceramic fiber material can alter various properties of the ceramic fiber material, such as thermal and/or electrical conductivity, and/or tensile strength, for example. For example, ceramics used in ballistic protection applications can benefit from increased toughness by the presence of the infused CNTs. The processes employed to make CNT-infused ceramic fiber materials provide CNTs with substantially uniform length and distribution to impart their useful properties uniformly over the ceramic fiber material that is being modified. Furthermore, the processes disclosed herein are suitable for the generation of CNT-infused ceramic fiber materials of spoolable dimensions.

The present disclosure is also directed, in part, to processes for making CNT-infused ceramic fiber materials. The processes disclosed herein can be applied to nascent ceramic fiber materials generated de novo before, or in lieu of, application of a typical sizing solution to the ceramic fiber material. Alternatively, the processes disclosed herein can utilize a commercial ceramic fiber material, for example, a ceramic fabric tape, that already has a sizing applied to its surface. In such embodiments, the sizing can be removed to provide a direct interface between the ceramic fiber material and the synthesized CNTs. After CNT synthesis further sizing agents can be applied to the ceramic fiber material as desired. Ceramic tapes and fabrics can also incorporate other fiber types, such as a glass fiber material. Processes of the present invention apply equally to glass fiber types, thus allowing functionalization of complex higher order structures having multiple fiber types.

The processes described herein allow for the continuous production of carbon nanotubes of uniform length and distribution along spoolable lengths of ceramic tow, roving, yarns, tapes, fabrics and the like. While various mats, woven and non-woven fabrics and the like can be functionalized by processes of the invention, it is also possible to generate such higher ordered structures from the parent tow, yarn or the like after CNT functionalization of these parent materials. For example, a CNT-infused chopped strand mat can be generated from a CNT-infused ceramic fiber yarn.

As used herein the term “ceramic fiber material” refers to any material which has ceramic fiber as its elementary structural component. The term encompasses fibers, filaments, yarns, tows, rovings, tapes, woven and non-woven fabrics, plies, mats, and other 3D woven structures. As used herein, the term “ceramic” encompasses any refractory and/or technical crystalline or partially crystalline inorganic, non-metallic solid prepared by the action of heat and subsequent cooling. One skilled in the art will recognize that glass is also a type of ceramic, however, glass is amorphous. By “amorphous” it is meant the absence of any long range crystalline order. Thus, while glass can also be functionalized according to processes described herein, the term “ceramic fiber materials,” as used herein, specifically refers to non-amorphous oxides, carbides, borides, nitrides, silicides, and the like. The term “ceramic fiber material” is also intended to include basalt fiber materials as known in the art.

As used herein the term “spoolable dimensions” refers to ceramic fiber materials having at least one dimension that is not limited in length, allowing for the material to be stored on a spool or mandrel. Ceramic fiber materials of “spoolable dimensions” have at least one dimension that indicates the use of either batch or continuous processing for CNT infusion as described herein. One ceramic fiber material of spoolable dimensions that is commercially available is exemplified by Nextel 720-750, an alumina silicate ceramic fiber roving with a tex value of 333 (1 tex=1 g/1,000 m) or 1500 yard/lb (3M, St. Paul, Minn.). Commercial ceramic fiber rovings, in particular, can be obtained on 5, 10, 20, 50, and 100 lb. spools, for example. Processes of the invention operate readily with 5 to 20 lb. spools, although larger spools are usable. Moreover, a pre-process operation can be incorporated that divides very large spoolable lengths, for example 100 lb. or more, into easy to handle dimensions, such as two 50 lb spools.

As used herein, the term “carbon nanotube” (CNT, plural CNTs) refers to any of a number of cylindrically-shaped allotropes of carbon of the fullerene family including single-walled carbon nanotubes (SWNTs), double-walled carbon nanotubes (DWNTS), multi-walled carbon nanotubes (MWNTs). CNTs can be capped by a fullerene-like structure or open-ended. CNTs include those that encapsulate other materials.

As used herein “uniform in length” refers to length of CNTs grown in a reactor. “Uniform length” means that the CNTs have lengths with tolerances of plus or minus about 20% of the total CNT length or less, for CNT lengths varying from between about 1 micron to about 500 microns. At very short lengths, such as 1-4 microns, this error may be in a range from between about plus or minus 20% of the total CNT length up to about plus or minus 1 micron, that is, somewhat more than about 20% of the total CNT length. Although uniformity in CNT length can be obtained across the entirety of any length of spoolable ceramic fiber material, processes of the invention also allow the CNT length to vary in discrete sections of any portion of the spoolable material. Thus, for example, a spoolable length of ceramic fiber material can have uniform CNT lengths within any number of sections, each section having any desired CNT length. Such sections of different CNT length can appear in any order and can optionally include sections that are void of CNTs. Such control of CNT length is made possible by varying the linespeed of the process, the flow rates of the carrier and carbon feedstock gases and reaction temperatures. All these variables in the process can be automated and run by computer control.

As used herein “uniform in distribution” refers to the consistency of density of CNTs on a ceramic fiber material. “Uniform distribution” means that the CNTs have a density on the ceramic fiber material with tolerances of plus or minus about 10% coverage defined as the percentage of the surface area of the fiber covered by CNTs. This is equivalent to ±1500 CNTs/μm² for an 8 nm diameter CNT with 5 walls. Such a figure assumes the space inside the CNTs as fillable.

As used herein, the term “infused” means bonded and “infusion” means the process of bonding. Such bonding can involve direct covalent bonding, ionic bonding, pi-pi, and/or van der Waals force-mediated physisorption. Bonding can also be indirect, whereby CNTs are infused to the ceramic fiber via an intervening transition metal nanoparticle disposed between the CNTs and ceramic fiber material. In the CNT-infused ceramic fiber materials disclosed herein, the carbon nanotubes can be “infused” to the ceramic fiber material both directly and indirectly as described above. The manner in which a CNT is “infused” to a ceramic fiber materials is referred to as a “bonding motif.”

As used herein, the term “transition metal” refers to any element or alloy of elements in the d-block of the periodic table. The term “transition metal” also includes salt forms of the base transition metal element such as oxides, carbides, nitrides, and the like.

As used herein, the term “nanoparticle” or NP (plural NPs), or grammatical equivalents thereof refers to particles sized between about 0.1 to about 100 nanometers in equivalent spherical diameter, although the NPs need not be spherical in shape. Transition metal NPs, in particular, serve as catalysts for further CNT growth on the ceramic fiber materials.

As used herein, the term “sizing agent,” “fiber sizing agent,” or just “sizing,” refers collectively to materials used in the manufacture of ceramic fibers as a coating to protect the integrity of ceramic fibers, provide enhanced interfacial interactions between a ceramic fiber and a matrix material in a composite, and/or alter and/or enhance particular physical properties of a ceramic fiber. In some embodiments, CNTs infused to ceramic fiber materials behave as a sizing agent.

As used herein, the term “matrix material” refers to a bulk material than can serve to organize sized CNT-infused ceramic fiber materials in particular orientations, including random orientation. The matrix material can benefit from the presence of the CNT-infused ceramic fiber material by imparting some aspects of the physical and/or chemical properties of the CNT-infused ceramic fiber material to the matrix material.

As used herein, the term “material residence time” refers to the amount of time a discrete point along a glass fiber material of spoolable dimensions is exposed to CNT growth conditions during the CNT infusion processes described herein. This definition includes the residence time when employing multiple CNT growth chambers.

As used herein, the term “linespeed” refers to the speed at which a glass fiber material of spoolable dimensions can be fed through the CNT infusion processes described herein, where linespeed is a velocity determined by dividing CNT chamber(s) length by the material residence time.

In some embodiments, the present invention provides a composition that includes a carbon nanotube (CNT)-infused ceramic fiber material. The CNT-infused ceramic fiber material includes a ceramic fiber material of spoolable dimensions and carbon nanotubes (CNTs) bonded to the ceramic fiber material. The bonding to the ceramic fiber material can include a bonding motif such as direct bonding of the CNTs to the ceramic fiber material, indirect bonding via a transition metal nanoparticle disposed between the CNTs and the ceramic fiber material, and mixtures thereof.

Without being bound by theory, the transition metal nanoparticles, which serve as a CNT-forming catalyst, can catalyze CNT growth by forming a CNT growth seed structure. The CNT-forming catalyst can “float” during CNT synthesis moving along the leading edge of CNT growth such that when CNT synthesis is complete, the CNT-forming catalyst resides at the CNT terminus distal to the ceramic fiber material. In such a case, the CNT structure is infused directly to the ceramic fiber material. Similarly, the CNT-forming catalyst can “float,” but can appear in the middle of a completed CNT structure, which can be the result of a non-catalyzed, seeded growth rate exceeding the catalyzed growth rate. Nonetheless, the resulting CNT infusion occurs directly to the ceramic fiber material. Finally, the CNT-forming catalyst can remain at the base of the ceramic fiber material and infused to it. In such a case, the seed structure initially formed by the transition metal nanoparticle catalyst is sufficient for continued non-catalyzed CNT growth without a “floating” catalyst. One skilled in the art will recognize the value of a CNT-growth process that can control whether the catalyst “floats” or not. For example, when a catalyst is substantially all “floating” the CNT-forming transition metal catalyst can be optionally removed after CNT synthesis without affecting the infusion of the CNTs to the ceramic fiber material. Regardless of the nature of the actual bond that is formed between the carbon nanotubes and the ceramic fiber material, direct or indirect bonding of the infused CNT is robust and allows the CNT-infused ceramic fiber material to exhibit carbon nanotube properties and/or characteristics.

Compositions having CNT-infused ceramic fiber materials are provided in which the CNTs are substantially uniform in length. In the continuous process described herein, the residence time of the ceramic fiber material in a CNT growth chamber can be modulated to control CNT growth and ultimately, CNT length. This provides a means to control specific properties of the CNTs grown. CNT length can also be controlled through modulation of the carbon feedstock and carrier gas flow rates as well as growth temperature. Additional control of the CNT properties can be obtained by controlling, for example, the size of the catalyst used to prepare the CNTs. For example, 1 nm transition metal nanoparticle catalysts can be used to provide SWNTs in particular. Larger catalysts can be used to prepare predominantly MWNTs.

Additionally, the CNT growth processes employed are useful for providing a CNT-infused ceramic fiber material with uniformly distributed CNTs on ceramic fiber materials while avoiding bundling and/or aggregation of the CNTs that can occur in processes in which pre-formed CNTs are suspended or dispersed in a solvent solution and applied by hand to the ceramic fiber material. Such aggregated CNTs tend to adhere weakly to a ceramic fiber material and the characteristic CNT properties are weakly expressed, if at all. In some embodiments, the maximum distribution density, expressed as percent coverage, that is, the surface area of fiber covered, can be as high as about 55% assuming about 8 nm diameter CNTs with 5 walls. This coverage is calculated by considering the space inside the CNTs as being “fillable” space. Various distribution/density values can be achieved by varying catalyst dispersion on the surface as well as controlling gas composition, process speed, and growth temperature. Typically for a given set of parameters, a percent coverage within about 10% can be achieved across a fiber surface. Higher density and shorter CNTs are useful for improving mechanical properties, while longer CNTs with lower density are useful for improving thermal and electrical properties, although increased density is still favorable. A lower density can result when longer CNTs are grown. This can be the result of the higher temperatures and more rapid growth causing lower catalyst particle yields.

The compositions of the invention having CNT-infused ceramic fiber materials can include a ceramic fiber material such as a ceramic filament, a ceramic tow, a ceramic yarn, a ceramic roving, a ceramic tape, a ceramic fiber-braid, unidirectional fabrics and tapes, an optical fiber, a ceramic roving fabric, a non-woven ceramic fiber mat, a ceramic fiber ply, and other 3D woven fabrics. Ceramic filaments include high aspect ratio ceramic fibers having diameters ranging in size from between about 1 micron to about 50 microns. Ceramic tows are generally compactly associated bundles of filaments and are usually twisted together to give yarns. A ceramic tow can also be flattened into tape-like structures.

Yarns include closely associated bundles of twisted filaments. Each filament diameter in a yarn is relatively uniform. Yarns have varying weights described by their ‘tex,’ expressed as weight in grams of 1000 linear meters, or denier, expressed as weight in pounds of 10,000 yards, with a typical tex range usually being between about 50 to about 1200 tex. Rovings include loosely associated bundles of untwisted filaments. As in yarns, filament diameter in a roving is generally uniform. Rovings also have varying weights and the tex range is usually between about 50 and about 1200 tex.

Ceramic tapes (or wider sheets) are materials that can be drawn directly from a ceramic melt or assembled as weaves. Ceramic tapes can vary in width and are generally two-sided structures similar to ribbon. Processes of the present invention are compatible with CNT infusion on one or both sides of a tape. CNT-infused tapes can resemble a “carpet” or “forest” on a flat substrate surface. Again, processes of the invention can be performed in a continuous mode to functionalize spools of tape.

Ceramic fiber-braids represent rope-like structures of densely packed ceramic fibers. Such structures can be assembled from ceramic yarns, for example. Braided structures can include a hollow portion or a braided structure can be assembled about another core material.

In some embodiments a number of primary ceramic fiber material structures can be organized into fabric or sheet-like structures. These include, for example, ceramic roving fabric, non-woven ceramic fiber mat and ceramic fiber ply, in addition to the tapes described above. Such higher ordered structures can be assembled from parent tows, yarns, rovings, filaments or the like, with CNTs already infused in the parent fiber. Alternatively such structures can serve as the substrate for the CNT infusion processes described herein.

The ceramic-type used in the ceramic fiber material can be any type, including for example, oxides such as alumina and zirconia, carbides, such as boron carbide, silicon carbide, and tungsten carbide, and nitrides, such as boron nitride and silicon nitride. Other ceramic fiber materials include, for example, borides and silicides. Ceramic fiber materials may occur as composite materials with other fiber types. It is common to find fabric-like ceramic fiber materials that also incorporate glass fiber, for example.

CNTs useful for infusion to ceramic fiber materials include single-walled CNTs, double-walled CNTs, multi-walled CNTs, and mixtures thereof. The exact CNTs to be used depends on the application of the CNT-infused ceramic fiber. CNTs can be used for thermal and/or electrical conductivity applications, or as insulators. In some embodiments, the infused carbon nanotubes are single-wall nanotubes. In some embodiments, the infused carbon nanotubes are multi-wall nanotubes. In some embodiments, the infused carbon nanotubes are a combination of single-wall and multi-wall nanotubes. There are some differences in the characteristic properties of single-wall and multi-wall nanotubes that, for some end uses of the fiber, dictate the synthesis of one or the other type of nanotube. For example, single-walled nanotubes can be semi-conducting or metallic, while multi-walled nanotubes are metallic.

CNTs lend their characteristic properties such as mechanical strength, low to moderate electrical resistivity, high thermal conductivity, and the like to the CNT-infused ceramic fiber material. For example, in some embodiments, the electrical resistivity of a carbon nanotube-infused ceramic fiber material is lower than the electrical resistivity of a parent ceramic fiber material. More generally, the extent to which the resulting CNT-infused fiber expresses these characteristics can be a function of the extent and density of coverage of the ceramic fiber by the carbon nanotubes. Any amount of the fiber surface area, from 0-55% of the fiber can be covered assuming an 8 nm diameter, 5-walled MWNT (again this calculation counts the space inside the CNTs as fillable). This number is lower for smaller diameter CNTs and more for greater diameter CNTs. 55% surface area coverage is equivalent to about 15,000 CNTs/micron². Further CNT properties can be imparted to the ceramic fiber material in a manner dependent on CNT length, as described above. Infused CNTs can vary in length ranging from between about 1 micron to about 500 microns, including 1 micron, 2 microns, 3 microns, 4 micron, 5, microns, 6, microns, 7 microns, 8 microns, 9 microns, 10 microns, 15 microns, 20 microns, 25 microns, 30 microns, 35 microns, 40 microns, 45 microns, 50 microns, 60 microns, 70 microns, 80 microns, 90 microns, 100 microns, 150 microns, 200 microns, 250 microns, 300 microns, 350 microns, 400 microns, 450 microns, 500 microns, and all values in between. CNTs can also be less than about 1 micron in length, including about 0.5 microns, for example. CNTs can also be greater than 500 microns, including for example, 510 microns, 520 microns, 550 microns, 600 microns, 700 microns and all values in between.

Compositions of the invention can incorporate CNTs having a length from about 1 micron to about 10 microns. Such CNT lengths can be useful in application to increase shear strength. CNTs can also have a length from about 5-70 microns. Such CNT lengths can be useful in application to increase tensile strength if the CNTs are aligned in the fiber direction. CNTs can also have a length from about 10 microns to about 100 microns. Such CNT lengths can be useful to increase electrical/thermal properties as well as mechanical properties. The process used in the invention can also provide CNTs having a length from about 100 microns to about 500 microns, which can also be beneficial to increase electrical and thermal properties. Such control of CNT length is readily achieved through modulation of carbon feedstock and inert gas flow rates coupled with varying linespeeds and growth temperature. In some embodiments, compositions that include spoolable lengths of CNT-infused ceramic fiber materials can have various uniform regions with different lengths of CNTs as described above. For example, it can be desirable to have a first portion of CNT-infused ceramic fiber material with uniformly shorter CNT lengths to enhance tensile or shear strength properties, and a second portion of the same spoolable material with a uniform longer CNT length to enhance electrical or thermal properties. More specifically, a section of spoolable length can have short CNTs for increasing tensile or shear strength, while another section of the same spoolable ceramic fiber material has longer CNTs to enhance thermal or electrical conductive properties. These different sections of the spoolable ceramic fiber material can be laid up in a molded structure, or the like, and can be organized in a matrix material.

Processes of the invention for CNT infusion to ceramic fiber materials allow control of the CNT lengths with uniformity and in a continuous process allowing spoolable ceramic fiber materials to be functionalized with CNTs at high rates. With material residence times between 5 to 300 seconds, linespeeds in a continuous process for a system that is 3 feet long can be in a range anywhere from about 0.5 ft/min to about 36 ft/min and greater. The speed selected depends on various parameters as explained further below.

In some embodiments, a material residence time in a CNT growth chamber can be from about 5 to about 30 seconds to produce CNTs having a length between about 1 micron to about 10 microns. In some embodiments, a material residence time in a CNT growth chamber can be from of about 30 to about 180 seconds to produce CNTs having a length between about 10 microns to about 100 microns. In still further embodiments, a material residence time in a CNT growth chamber can be from about 180 to about 300 seconds to produce CNTs having a length between about 100 microns to about 500 microns. One skilled in the art will recognize that these lengths are approximate and that they can be further altered by reaction temperature, concentration and flow rates of the carrier gas and carbon feedstock, for example.

In some embodiments, CNT-infused ceramic fiber materials of the invention can include a barrier coating. Barrier coatings can include for example an alkoxysilane, methylsiloxane, an alumoxane, alumina nanoparticles, spin on glass and glass nanoparticles. As described below, the CNT-forming catalyst can be added to the uncured barrier coating material and then applied to the ceramic fiber material together. In other embodiments the barrier coating material can be added to the ceramic fiber material prior to deposition of the CNT-forming catalyst. The barrier coating material can be of a thickness sufficiently thin to allow exposure of the CNT-forming catalyst to the carbon feedstock for subsequent CVD growth. In some embodiments, the thickness is less than or about equal to the effective diameter of the CNT-forming catalyst. In some embodiments, the thickness of the barrier coating is in a range from between about 10 nm to about 100 nm. The barrier coating can also be less than 10 nm, including 1 nm, 2 nm, 3 nm, 4 nm, 5 nm, 6 nm, 7 nm, 8 nm, 9 nm, 10 nm, and any value in between.

The infused CNTs disclosed herein can effectively function as a replacement for conventional ceramic fiber “sizing.” The infused CNTs are more robust than conventional sizing materials and can improve the fiber-to-matrix interface in composite materials and, more generally, improve fiber-to-fiber interfaces. Indeed, the CNT-infused ceramic fiber materials disclosed herein are themselves composite materials in the sense the CNT-infused ceramic fiber material properties will be a combination of those of the ceramic fiber material as well as those of the infused CNTs. Consequently, embodiments of the present invention provide a means to impart desired properties to a ceramic fiber material that otherwise lack such properties or possesses them in insufficient measure. Ceramic fiber materials can be tailored or engineered to meet the requirements of specific applications. The CNTs acting as sizing can protect ceramic fiber materials from absorbing moisture due to the hydrophobic CNT structure. Moreover, hydrophobic matrix materials, as further exemplified below, interact well with hydrophobic CNTs to provide improved fiber to matrix interactions.

Despite the beneficial properties imparted to a ceramic fiber material having infused CNTs described above, the compositions of the present invention can include further “conventional” sizing agents. Such sizing agents vary widely in type and function and include, for example, surfactants, anti-static agents, lubricants, siloxanes, alkoxysilanes, aminosilanes, silanes, silanols, polyvinyl alcohol, starch, and mixtures thereof. Such secondary sizing agents can be used to protect the CNTs themselves or provide further properties to the fiber not imparted by the presence of the infused CNTs.

Compositions of the present invention can further include a matrix material to form a composite with the CNT-infused ceramic fiber material. Such matrix materials can include, for example, an epoxy, a polyester, a vinylester, a polyetherimide, a polyetherketoneketone, a polyphthalamide, a polyetherketone, a polytheretherketone, a polyimide, a phenol-formaldehyde, and a bismaleimide. Matrix materials useful in the present invention can include any of the known matrix materials (see Mel M. Schwartz, Composite Materials Handbook (2d ed. 1992)). Matrix materials more generally can include resins (polymers), both thermosetting and thermoplastic, metals, ceramics, and cements.

Thermosetting resins useful as matrix materials include phthalic/maelic type polyesters, vinyl esters, epoxies, phenolics, cyanates, bismaleimides, and nadic end-capped polyimides (e.g., PMR-15). Thermoplastic resins include polysulfones, polyamides, polycarbonates, polyphenylene oxides, polysulfides, polyether ether ketones, polyether sulfones, polyamide-imides, polyetherimides, polyimides, polyarylates, and liquid crystalline polyester.

Metals useful as matrix materials include alloys of aluminum such as aluminum 6061, 2024, and 713 aluminum braze. Ceramics useful as matrix materials include lithium aluminosilicate, oxides such as alumina and mullite, nitrides such as silicon nitride, and carbides such as silicon carbide. Cements useful as matrix materials include carbide-base cermets (tungsten carbide, chromium carbide, and titanium carbide), refractory cements (tungsten-thoria and barium-carbonate-nickel), chromium-alumina, nickel-magnesia iron-zirconium carbide. Any of the above-described matrix materials can be used alone or in combination.

In some embodiments the present invention provides a continuous process for CNT infusion that includes (a) disposing a carbon nanotube-forming catalyst on a surface of a ceramic fiber material of spoolable dimensions; and (b) synthesizing carbon nanotubes directly on the ceramic fiber material, thereby forming a carbon nanotube-infused ceramic fiber material. In some embodiments, a barrier coating can be employed as further detailed below.

For a 9 foot long system, the linespeed of the process can range from between about 1.5 ft/min to about 108 ft/min. The linespeeds achieved by the process described herein allow the formation of commercially relevant quantities of CNT-infused ceramic fiber materials with short production times. For example, at 36 ft/min linespeed, the quantities of CNT-infused ceramic fibers (over 5% infused CNTs on fiber by weight) can exceed over 100 pound or more of material produced per day in a system that is designed to simultaneously process 5 separate rovings (20 lb/roving). Systems can be made to produce more rovings at once or at faster speeds by repeating growth zones. Moreover, some steps in the fabrication of CNTs, as known in the art, have prohibitively slow rates preventing a continuous mode of operation. For example, in a typical process known in the art, a CNT-forming catalyst reduction step can take 1-12 hours to perform. The process described herein overcomes such rate limiting steps.

The CNT-infused ceramic fiber material-forming processes of the invention can avoid CNT entanglement that occurs when trying to apply suspensions of pre-formed carbon nanotubes to fiber materials. That is, because pre-formed CNTs are not fused to the ceramic fiber material, the CNTs tend to bundle and entangle. The result is a poorly uniform distribution of CNTs that weakly adhere to the ceramic fiber material. However, processes of the present invention can provide, if desired, a highly uniform entangled CNT mat on the surface of the ceramic fiber material by reducing the growth density. The CNTs grown at low density are infused in the ceramic fiber material first. In such embodiments, the fibers do not grow dense enough to induce vertical alignment, the result is entangled mats on the ceramic fiber material surfaces. By contrast, manual application of pre-formed CNTs does not insure uniform distribution and density of a CNT mat on the ceramic fiber material.

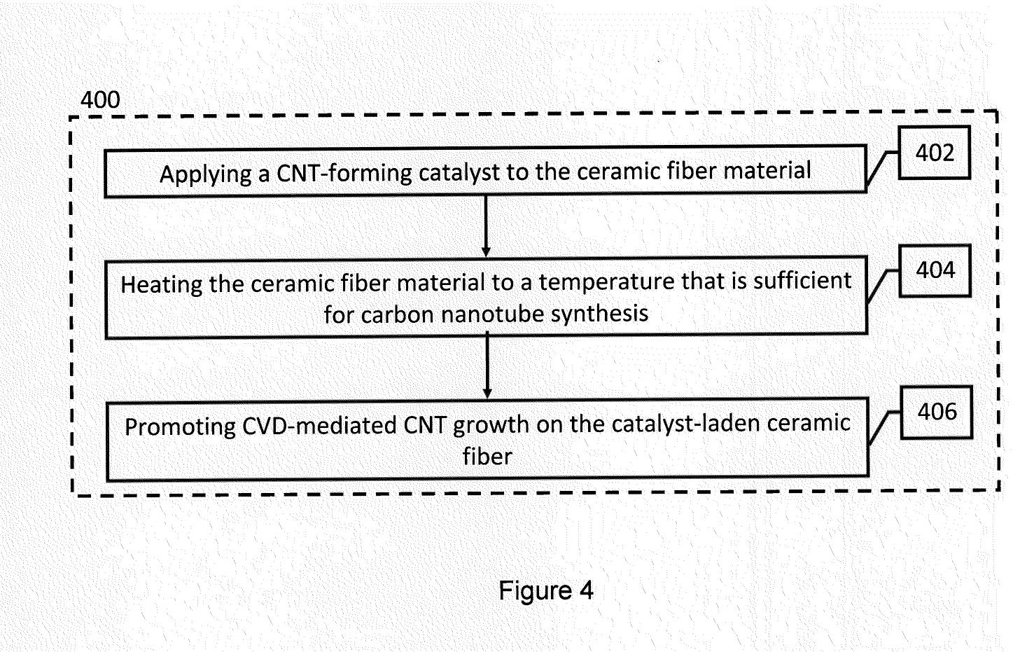

FIG. 4 depicts a flow diagram of process 400 for producing CNT-infused ceramic fiber material in accordance with an illustrative embodiment of the present invention.

Process 400 includes at least the operations of:
402: Applying a CNT-forming catalyst to the ceramic fiber material.
404: Heating the ceramic fiber material to a temperature that is sufficient for carbon nanotube synthesis.
406: Promoting CVD-mediated CNT growth on the catalyst-laden ceramic fiber.

To infuse carbon nanotubes into a ceramic fiber material, the carbon nanotubes are synthesized directly on the ceramic fiber material. In the illustrative embodiment, this is accomplished by first disposing nanotube-forming catalyst on the ceramic fiber, as per operation 402.

Preceding catalyst deposition, the ceramic fiber material can be optionally treated with a plasma to prepare the surface to accept the catalyst coating. For example, a plasma treated ceramic fiber material can provide a roughened ceramic fiber surface in which the CNT-forming catalyst can be deposited. The plasma process for “roughing” the surface of the ceramic fiber materials thus facilitates catalyst deposition. The roughness is typically on the scale of nanometers. In the plasma treatment process craters or depressions are formed that are nanometers deep and nanometers in diameter. Such surface modification can be achieved using a plasma of any one or more of a variety of different gases, including, without limitation, argon, helium, oxygen, nitrogen, and hydrogen. In order to treat ceramic fiber material in a continuous manner, ‘atmospheric’ plasma which does not require vacuum can be utilized. Plasma is created by applying voltage across two electrodes, which in turn ionizes the gaseous species between the two electrodes. A plasma environment can be applied to a carbon fiber substrate in a ‘downstream’ manner in which the ionized gases are flowed down toward the substrate. It is also possible to send the ceramic fiber substrate between the two electrodes and into the plasma environment to be treated.

In some embodiments, the ceramic fiber can be treated with a plasma environment prior to barrier coating application. For example, a plasma treated ceramic fiber material can have a higher surface energy and therefore allow for better wet-out and coverage of a barrier coating. The plasma process can also add roughness to the ceramic fiber surface allowing for better mechanical bonding of a barrier coating in the same manner as mentioned above.

Another optional step prior to or concomitant with deposition of the CNT-form catalyst is application of a barrier coating to the ceramic fiber material. Such a coating can include for example an alkoxysilane, an alumoxane, alumina nanoparticles, spin on ceramic and ceramic nanoparticles. This CNT-forming catalyst can be added to the uncured barrier coating material and then applied to the ceramic fiber material together, in one embodiment. In other embodiments the barrier coating material can be added to the ceramic fiber material prior to deposition of the CNT-forming catalyst. In such embodiments, the barrier coating can be partially cured prior to catalyst deposition. The barrier coating material should be of a thickness sufficiently thin to allow exposure of the CNT-forming catalyst to the carbon feedstock for subsequent CVD growth. In some embodiments, the thickness is less than or about equal to the effective diameter of the CNT-forming catalyst. Once the CNT-forming catalyst and barrier coating are in place, the barrier coating can be fully cured.

Without being bound by theory, the barrier coating can serve as an intermediate layer between the ceramic fiber material and the CNTs and serves to mechanically infuse the CNTs to the ceramic fiber material. Such mechanical infusion still provides a robust system in which the ceramic fiber material still serves as a platform for organizing the CNTs and the benefits of mechanical infusion with a barrier coating are similar to the indirect type fusion described herein above. Moreover, the benefit of including a barrier coating is the immediate protection it provides the ceramic fiber material from chemical damage due to exposure to moisture or the like at the temperatures used to promote CNT growth.

As described further below and in conjunction with FIG. 4, the catalyst is prepared as a liquid solution that contains a CNT-forming catalyst that comprises transition metal nanoparticles. The diameters of the synthesized nanotubes are related to the size of the metal particles as described above.

With reference to the illustrative embodiment of FIG. 4, carbon nanotube synthesis is shown based on a chemical vapor deposition (CVD) process and occurs at elevated temperatures. The specific temperature is a function of catalyst choice, but will typically be in a range of about 500 to 1000° C. Accordingly, operation 404 involves heating the ceramic fiber material to a temperature in the aforementioned range to support carbon nanotube synthesis.

In operation 406, CVD-promoted nanotube growth on the catalyst-laden ceramic fiber material is then performed. The CVD process can be promoted by, for example, a carbon-containing feedstock gas such as acetylene, ethylene, and/or ethanol. The CNT synthesis processes generally use an inert gas (nitrogen, argon, helium) as a primary carrier gas. The carbon feedstock is provided in a range from between about 0% to about 15% of the total mixture. A substantially inert environment for CVD growth is prepared by removal of moisture and oxygen from the growth chamber.

In the CNT synthesis process, CNTs grow at the sites of a CNT-forming transition metal nanoparticle catalyst. The presence of the strong plasma-creating electric field can be optionally employed to affect nanotube growth. That is, the growth tends to follow the direction of the electric field. By properly adjusting the geometry of the plasma spray and electric field, vertically-aligned CNTs (i.e., perpendicular to the ceramic fiber material) can be synthesized. Under certain conditions, even in the absence of a plasma, closely-spaced nanotubes will maintain a vertical growth direction resulting in a dense array of CNTs resembling a carpet or forest.

The operation of disposing a catalyst on the ceramic fiber material can be accomplished by spraying or dip coating a solution or by gas phase deposition via, for example, a plasma process. Thus, in some embodiments, after forming a solution of a catalyst in a solvent, catalyst can be applied by spraying or dip coating the ceramic fiber material with the solution, or combinations of spraying and dip coating. Either technique, used alone or in combination, can be employed once, twice, thrice, four times, up to any number of times to provide a ceramic fiber material that is sufficiently uniformly coated with CNT-forming catalyst. When dip coating is employed, for example, a ceramic fiber material can be placed in a first dip bath for a first residence time in the first dip bath. When employing a second dip bath, the ceramic fiber material can be placed in the second dip bath for a second residence time. For example, ceramic fiber materials can be subjected to a solution of CNT-forming catalyst for between about 3 seconds to about 90 seconds depending on the dip configuration and linespeed. Employing spraying or dip coating processes, a ceramic fiber material with a surface density of catalyst of less than about 5% surface coverage to as high as about 80% coverage, in which the CNT-forming catalyst nanoparticles are nearly monolayer. In some embodiments, the process of coating the CNT-forming catalyst on the ceramic fiber material should produce no more than a monolayer. For example, CNT growth on a stack of CNT-forming catalyst can erode the degree of infusion of the CNT to the ceramic fiber material. In other embodiments, the transition metal catalyst can be deposited on the ceramic fiber material using evaporation techniques, electrolytic deposition techniques, and other processes known to those skilled in the art, such as addition of the transition metal catalyst to a plasma feedstock gas as a metal organic, metal salt or other composition promoting gas phase transport.

Because processes of the invention are designed to be continuous, a spoolable ceramic fiber material can be dip-coated in a series of baths where dip coating baths are spatially separated. In a continuous process in which nascent ceramic fibers are being generated de novo, dip bath or spraying of CNT-forming catalyst can be the first step after sufficiently cooling the newly formed ceramic fiber material. Thus, application of a CNT-forming catalyst can be performed in lieu of application of a sizing. In other embodiments, the CNT-forming catalyst can be applied to newly formed ceramic fibers in the presence of other sizing agents. Such simultaneous application of CNT-forming catalyst and other sizing agents can still provide the CNT-forming catalyst in surface contact with the ceramic fiber material to insure CNT infusion. In yet further embodiments, the CNT-forming catalyst can be applied to nascent fibers by spray or dip coating while the ceramic fiber material is still sufficiently softened, for example, near or below the softening temperature, such that CNT-forming catalyst is slightly embedded in the surface of the ceramic fibers. When depositing the CNT-forming catalyst on such hot ceramic fiber materials, care should be given to not exceed the melting point of the CNT-forming catalyst causing the fusion of nanoparticles resulting in loss of control of the CNT characteristics, such as CNT diameter, for example.

The catalyst solution employed can be a transition metal nanoparticle which can be any d-block transition metal as described above. In addition, the nanoparticles can include alloys and non-alloy mixtures of d-block metals in elemental form or in salt form, and mixtures thereof. Such salt forms include, without limitation, oxides, carbides, and nitrides. Non-limiting exemplary transition metal NPs include Ni, Fe, Co, Mo, Cu, Pt, Au, and Ag and salts thereof and mixtures thereof. In some embodiments, such CNT-forming catalysts are disposed on the ceramic fiber by applying or infusing a CNT-forming catalyst directly to the ceramic fiber material. Many of these transition metal catalysts are readily commercially available from a variety of suppliers, including, for example, Ferrotec Corporation (Bedford, N.H.).

Catalyst solutions used for applying the CNT-forming catalyst to the ceramic fiber material can be in any common solvent that allows the CNT-forming catalyst to be uniformly dispersed throughout. Such solvents can include, without limitation, water, acetone, hexane, isopropyl alcohol, toluene, ethanol, methanol, tetrahydrofuran (THF), cyclohexane or any other solvent with controlled polarity to create an appropriate dispersion of the CNT-forming catalyst nanoparticles. Concentrations of CNT-forming catalyst can be in a range from about 1:1 to 1:10000 catalyst to solvent.

In some embodiments, after applying the CNT-forming catalyst to the ceramic fiber material, the ceramic fiber material can be heated to a softening temperature. This can aid in embedding the CNT-forming catalyst in the surface of the ceramic fiber material and can encourage seeded growth without catalyst “floating.” In some embodiments heating of the ceramic fiber material after disposing the catalyst on the ceramic fiber material can be at a temperature that is between about 500° C. and 1000° C. Heating to such temperatures, which can be used for CNT growth, can serve to remove any pre-existing sizing agents on the ceramic fiber material allowing deposition of the CNT-forming catalyst without prior removal of pre-existing sizing. In such embodiments, the CNT-forming catalyst may be on the surface of the sizing coating prior to heating, but after sizing removal is in surface contact with the ceramic fiber material. Heating at these temperatures can be performed prior to or substantially simultaneously with introduction of a carbon feedstock for CNT growth.

In some embodiments, the present invention provides a process that includes removing sizing agents from a ceramic fiber material, applying a CNT-forming catalyst to the ceramic fiber material after sizing removal, heating the ceramic fiber material to at least 500° C., and synthesizing carbon nanotubes on said ceramic fiber material. In some embodiments, operations of the CNT-infusion process include removing sizing from a ceramic fiber material, applying a CNT-forming catalyst to the ceramic fiber, heating the fiber to CNT-synthesis temperature and spraying carbon plasma onto the catalyst-laden ceramic fiber material. Thus, where commercial ceramic fiber materials are employed, processes for constructing CNT-infused ceramic fibers can include a discrete step of removing sizing from the ceramic fiber material before disposing the catalyst on the ceramic fiber material. Depending on the commercial sizing present, if it is not removed, then the CNT-forming catalyst may not be in surface contact with the ceramic fiber material, and this can prevent CNT fusion. In some embodiments, where sizing removal is assured under the CNT synthesis conditions, sizing removal can be performed after catalyst deposition but just prior to providing carbon feedstock.

The step of synthesizing carbon nanotubes can include numerous techniques for forming carbon nanotubes, including those disclosed in co-pending U.S. Patent Application No. US 2004/0245088 which is incorporated herein by reference. The CNTs grown on fibers of the present invention can be accomplished by techniques known in the art including, without limitation, micro-cavity, thermal or plasma-enhanced CVD techniques, laser ablation, arc discharge, and high pressure carbon monoxide (HiPCO). During CVD, in particular, a sized ceramic fiber material with CNT-forming catalyst disposed thereon, can be used directly. In some embodiments, any conventional sizing agents can be removed during CNT synthesis. In other embodiments other sizing agents are not removed, but do not hinder CNT synthesis and infusion to the ceramic fiber material due to the diffusion of the carbon source through the sizing. In some embodiments, acetylene gas is ionized to create a jet of cold carbon plasma for CNT synthesis. The plasma is directed toward the catalyst-bearing ceramic fiber material. Thus, in some embodiments synthesizing CNTs on a ceramic fiber material includes (a) forming a carbon plasma; and (b) directing the carbon plasma onto said catalyst disposed on the ceramic fiber material. The diameters of the CNTs that are grown are dictated by the size of the CNT-forming catalyst as described above. In some embodiments, the sized fiber substrate is heated to between about 550 to about 800° C. to facilitate CNT synthesis. To initiate the growth of CNTs, two gases are bled into the reactor: a process gas such as argon, helium, or nitrogen, and a carbon-containing gas, such as acetylene, ethylene, ethanol or methane. CNTs grow at the sites of the CNT-forming catalyst.

In some embodiments, the CVD growth is plasma-enhanced. A plasma can be generated by providing an electric field during the growth process. CNTs grown under these conditions can follow the direction of the electric field. Thus, by adjusting the geometry of the reactor vertically aligned carbon nanotubes can be grown radially about a cylindrical fiber. In some embodiments, a plasma is not required for radial growth about the fiber. For ceramic fiber materials that have distinct sides such as tapes, mats, fabrics, plies, and the like, catalyst can be disposed on one or both sides and correspondingly, CNTs can be grown on one or both sides as well.

As described above, CNT-synthesis is performed at a rate sufficient to provide a continuous process for functionalizing spoolable ceramic fiber materials. Numerous apparatus configurations facilitate such continuous synthesis as exemplified below.

In some embodiments, CNT-infused ceramic fiber materials can be constructed in an “all plasma” process. In such embodiments, ceramic fiber materials pass through numerous plasma-mediated steps to form the final CNT-infused product. The first of the plasma processes, can include a step of fiber surface modification. This is a plasma process for “roughing” the surface of the ceramic fiber material to facilitate catalyst deposition, as described above, or to facilitate wetting for application of a barrier coating. When used prior to application of a barrier coating, the barrier coated fiber can be also roughened for catalyst deposition. In some embodiments this is performed after curing the barrier coating. As described above, surface modification can be achieved using a plasma of any one or more of a variety of different gases, including, without limitation, argon, helium, oxygen, ammonia, hydrogen, and nitrogen.

After surface modification, the ceramic fiber material proceeds to catalyst application. This is a plasma process for depositing the CNT-forming catalyst on the fibers. The CNT-forming catalyst is typically a transition metal as described above. The transition metal catalyst can be added to a plasma feedstock gas as a precursor in the form of a ferrofluid, a metal organic, metal salt or other composition for promoting gas phase transport. The catalyst can be applied at room temperature in the ambient environment with neither vacuum nor an inert atmosphere being required. In some embodiments, the ceramic fiber material is cooled prior to catalyst application.

Continuing the all-plasma process, carbon nanotube synthesis occurs in a CNT-growth reactor. This can be achieved through the use of plasma-enhanced chemical vapor deposition, wherein carbon plasma is sprayed onto the catalyst-laden fibers. Since carbon nanotube growth occurs at elevated temperatures (typically in a range of about 500 to 1000° C. depending on the catalyst), the catalyst-laden fibers can be heated prior to exposing to the carbon plasma. For the infusion process, the ceramic fiber material can be optionally heated until it softens. After heating, the ceramic fiber material is ready to receive the carbon plasma. The carbon plasma is generated, for example, by passing a carbon containing gas such as acetylene, ethylene, ethanol, and the like, through an electric field that is capable of ionizing the gas. This cold carbon plasma is directed, via spray nozzles, to the ceramic fiber material. The ceramic fiber material can be in close proximity to the spray nozzles, such as within about 1 centimeter of the spray nozzles, to receive the plasma. In some embodiments, heaters are disposed above the ceramic fiber material at the plasma sprayers to maintain the elevated temperature of the ceramic fiber material.

Another configuration for continuous carbon nanotube synthesis involves a special rectangular reactor for the synthesis and growth of carbon nanotubes directly on ceramic fiber materials. The reactor can be designed for use in a continuous in-line process for producing carbon-nanotube bearing fibers. In some embodiments, CNTs are grown via a chemical vapor deposition (“CVD”) process at atmospheric pressure and at elevated temperature in the range of about 550° C. to about 800° C. in a multi-zone reactor. The fact that the synthesis occurs at atmospheric pressure is one factor that facilitates the incorporation of the reactor into a continuous processing line for CNT-on-fiber synthesis. Another advantage consistent with in-line continuous processing using such a zone reactor is that CNT growth occurs in a seconds, as opposed to minutes (or longer) as in other procedures and apparatus configurations typical in the art.

CNT synthesis reactors in accordance with the various embodiments include the following features:

Rectangular Configured Synthesis Reactors: The cross section of a typical CNT synthesis reactor known in the art is circular. There are a number of reasons for this including, for example, historical reasons (cylindrical reactors are often used in laboratories) and convenience (flow dynamics are easy to model in cylindrical reactors, heater systems readily accept circular tubes (quartz, etc.), and ease of manufacturing. Departing from the cylindrical convention, the present invention provides a CNT synthesis reactor having a rectangular cross section. The reasons for the departure are as follows: 1. Since many ceramic fiber materials that can be processed by the reactor are relatively planar such as flat tape or sheet-like in form, a circular cross section is an inefficient use of the reactor volume. This inefficiency results in several drawbacks for cylindrical CNT synthesis reactors including, for example, a) maintaining a sufficient system purge; increased reactor volume requires increased gas flow rates to maintain the same level of gas purge. This results in a system that is inefficient for high volume production of CNTs in an open environment; b) increased carbon feedstock gas flow; the relative increase in inert gas flow, as per a) above, requires increased carbon feedstock gas flows. Consider that the volume of a 12K ceramic fiber roving is 2000 times less than the total volume of a synthesis reactor having a rectangular cross section. In an equivalent growth cylindrical reactor (i.e., a cylindrical reactor that has a width that accommodates the same planarized ceramic fiber material as the rectangular cross-section reactor), the volume of the ceramic fiber material is 17,500 times less than the volume of the chamber. Although gas deposition processes, such as CVD, are typically governed by pressure and temperature alone, volume has a significant impact on the efficiency of deposition. With a rectangular reactor there is a still excess volume. This excess volume facilitates unwanted reactions; yet a cylindrical reactor has about eight times that volume. Due to this greater opportunity for competing reactions to occur, the desired reactions effectively occur more slowly in a cylindrical reactor chamber. Such a slow down in CNT growth, is problematic for the development of a continuous process. One benefit of a rectangular reactor configuration is that the reactor volume can be decreased by using a small height for the rectangular chamber to make this volume ratio better and reactions more efficient. In some embodiments of the present invention, the total volume of a rectangular synthesis reactor is no more than about 3000 times greater than the total volume of a ceramic fiber material being passed through the synthesis reactor. In some further embodiments, the total volume of the rectangular synthesis reactor is no more than about 4000 times greater than the total volume of the ceramic fiber material being passed through the synthesis reactor. In some still further embodiments, the total volume of the rectangular synthesis reactor is less than about 10,000 times greater than the total volume of the ceramic fiber material being passed through the synthesis reactor. Additionally, it is notable that when using a cylindrical reactor, more carbon feedstock gas is required to provide the same flow percent as compared to reactors having a rectangular cross section. It should be appreciated that in some other embodiments, the synthesis reactor has a cross section that is described by polygonal forms that are not rectangular, but are relatively similar thereto and provide a similar reduction in reactor volume relative to a reactor having a circular cross section; c) problematic temperature distribution; when a relatively small-diameter reactor is used, the temperature gradient from the center of the chamber to the walls thereof is minimal. But with increased size, such as would be used for commercial-scale production, the temperature gradient increases. Such temperature gradients result in product quality variations across a ceramic fiber material substrate (i.e., product quality varies as a function of radial position). This problem is substantially avoided when using a reactor having a rectangular cross section. In particular, when a planar substrate is used, reactor height can be maintained constant as the size of the substrate scales upward. Temperature gradients between the top and bottom of the reactor are essentially negligible and, as a consequence, thermal issues and the product-quality variations that result are avoided. 2. Gas introduction: Because tubular furnaces are normally employed in the art, typical CNT synthesis reactors introduce gas at one end and draw it through the reactor to the other end. In some embodiments disclosed herein, gas can be introduced at the center of the reactor or within a target growth zone, symmetrically, either through the sides or through the top and bottom plates of the reactor. This improves the overall CNT growth rate because the incoming feedstock gas is continuously replenishing at the hottest portion of the system, which is where CNT growth is most active. This constant gas replenishment is an important aspect to the increased growth rate exhibited by the rectangular CNT reactors.

Zoning. Chambers that provide a relatively cool purge zone depend from both ends of the rectangular synthesis reactor. Applicants have determined that if hot gas were to mix with the external environment (i.e., outside of the reactor), there would be an increase in degradation of the ceramic fiber material. The cool purge zones provide a buffer between the internal system and external environments. Typical CNT synthesis reactor configurations known in the art typically require that the substrate is carefully (and slowly) cooled. The cool purge zone at the exit of the present rectangular CNT growth reactor achieves the cooling in a short period of time, as required for the continuous in-line processing.

Non-contact, hot-walled, metallic reactor. In some embodiments, a hot-walled reactor is made of metal is employed, in particular stainless steel. This may appear counterintuitive because metal, and stainless steel in particular, is more susceptible to carbon deposition (i.e., soot and by-product formation). Thus, most CNT reactor configurations use quartz reactors because there is less carbon deposited, quartz is easier to clean, and quartz facilitates sample observation. However, Applicants have observed that the increased soot and carbon deposition on stainless steel results in more consistent, faster, more efficient, and more stable CNT growth. Without being bound by theory it has been indicated that, in conjunction with atmospheric operation, the CVD process occurring in the reactor is diffusion limited. That is, the catalyst is “overfed;” too much carbon is available in the reactor system due to its relatively higher partial pressure (than if the reactor was operating under partial vacuum). As a consequence, in an open system—especially a clean one—too much carbon can adhere to catalyst particles, compromising their ability to synthesize CNTs. In some embodiments, the rectangular reactor is intentionally run when the reactor is “dirty,” that is with soot deposited on the metallic reactor walls. Once carbon deposits to a monolayer on the walls of the reactor, carbon will readily deposit over itself. Since some of the available carbon is “withdrawn” due to this mechanism, the remaining carbon feedstock, in the form of radicals, react with the catalyst at a rate that does not poison the catalyst. Existing systems run “cleanly” which, if they were open for continuous processing, would produced a much lower yield of CNTs at reduced growth rates.

Although it is generally beneficial to perform CNT synthesis “dirty” as described above, certain portions of the apparatus, such as gas manifolds and inlets, can nonetheless negatively impact the CNT growth process when soot creates blockages. In order to combat this problem, such areas of the CNT growth reaction chamber can be protected with soot inhibiting coatings such as silica, alumina, or MgO. In practice, these portions of the apparatus can be dip-coated in these soot inhibiting coatings. Metals such as INVAR® can be used with these coatings as INVAR has a similar CTE (coefficient of thermal expansion) ensuring proper adhesion of the coating at higher temperatures, preventing the soot from significantly building up in critical zones.

Combined Catalyst Reduction and CNT Synthesis. In the CNT synthesis reactor disclosed herein, both catalyst reduction and CNT growth occur within the reactor. This is significant because the reduction step cannot be accomplished timely enough for use in a continuous process if performed as a discrete operation. In a typical process known in the art, a reduction step typically takes 1-12 hours to perform. Both operations occur in a reactor in accordance with the present invention due, at least in part, to the fact that carbon feedstock gas is introduced at the center of the reactor, not the end as would be typical in the art using cylindrical reactors. The reduction process occurs as the fibers enter the heated zone; by this point, the gas has had time to react with the walls and cool off prior to reacting with the catalyst and causing the oxidation reduction (via hydrogen radical interactions). It is this transition region where the reduction occurs. At the hottest isothermal zone in the system, the CNT growth occurs, with the greatest growth rate occurring proximal to the gas inlets near the center of the reactor.

In some embodiments, when loosely affiliated ceramic fiber materials, such as ceramic roving are employed, the continuous process can include steps that spreads out the strands and/or filaments of the roving. Thus, as a roving is unspooled it can be spread using a vacuum-based fiber spreading system, for example. When employing sized ceramic fibers, which can be relatively stiff, additional heating can be employed in order to “soften” the roving to facilitate fiber spreading. The spread fibers which comprise individual filaments can be spread apart sufficiently to expose an entire surface area of the filaments, thus allowing the roving to more efficiently react in subsequent process steps. For example, the spread ceramic roving can pass through a surface treatment step that is composed of a plasma system as described above. After a barrier coating is applied, the roughened, spread fibers then can pass through a CNT-forming catalyst dip bath. The result is fibers of the ceramic roving that have catalyst particles distributed radially on their surface. The catalyzed-laden fibers of the roving then enter an appropriate CNT growth chamber, such as the rectangular chamber described above, where a flow through atmospheric pressure CVD or PE-CVD process is used to synthesize the CNTs at rates as high as several microns per second. The fibers of the roving, now with radially aligned CNTs, exit the CNT growth reactor.

In some embodiments, CNT-infused ceramic fiber materials can pass through yet another treatment process that, in some embodiments is a plasma process used to functionalize the CNTs. Additional functionalization of CNTs can be used to promote their adhesion to particular resins. Thus, in some embodiments, the present invention provides CNT-infused ceramic fiber materials having functionalized CNTs.

As part of the continuous processing of spoolable ceramic fiber materials, the a CNT-infused ceramic fiber material can further pass through a sizing dip bath to apply any additional sizing agents which can be beneficial in a final product. Finally if wet winding is desired, the CNT-infused ceramic fiber materials can be passed through a resin bath and wound on a mandrel or spool. The resulting ceramic fiber material/resin combination locks the CNTs on the ceramic fiber material allowing for easier handling and composite fabrication. In some embodiments, CNT infusion is used to provide improved filament winding. Thus, CNTs formed on ceramic fibers such as ceramic roving, are passed through a resin bath to produce resin-impregnated, CNT-infused ceramic roving. After resin impregnation, the ceramic roving can be positioned on the surface of a rotating mandrel by a delivery head. The roving can then be wound onto the mandrel in a precise geometric pattern in known fashion.

The winding process described above provides pipes, tubes, or other forms as are characteristically produced via a male mold. But the forms made from the winding process disclosed herein differ from those produced via conventional filament winding processes. Specifically, in the process disclosed herein, the forms are made from composite materials that include CNT-infused roving. Such forms will therefore benefit from enhanced strength and the like, as provided by the CNT-infused roving. Example III below describes a process for producing a spoolable CNT-infused ceramic roving with linespeeds as high as 5 ft/min continuously using the processes described above.

In some embodiments, a continuous process for infusion of CNTs on spoolable glass fiber materials can achieve a linespeed between about 0.5 ft/min to about 36 ft/min. In this embodiment where the system is 3 feet long and operating at a 750° C. growth temperature, the process can be run with a linespeed of about 6 ft/min to about 36 ft/min to produce, for example, CNTs having a length between about 1 micron to about 10 microns. The process can also be run with a linespeed of about 1 ft/min to about 6 ft/min to produce, for example, CNTs having a length between about 10 microns to about 100 microns. The process can be run with a linespeed of about 0.5 ft/min to about 1 ft/min to produce, for example, CNTs having a length between about 100 microns to about 200 microns. The CNT length is not tied only to linespeed and growth temperature, however, the flow rate of both the carbon feedstock and the inert carrier gases can also influence CNT length. In some embodiments, more than one ceramic material can be run simultaneously through the process. For example, multiple tapes rovings, filaments, strand and the like can be run through the process in parallel. Thus, any number of pre-fabricated spools of ceramic fiber material can be run in parallel through the process and re-spooled at the end of the process. The number of spooled ceramic fiber materials that can be run in parallel can include one, two, three, four, five, six, up to any number that can be accommodated by the width of the CNT-growth reaction chamber. Moreover, when multiple ceramic fiber materials are run through the process, the number of collection spools can be less than the number of spools at the start of the process. In such embodiments, ceramic strands, rovings, or the like can be sent through a further process of combining such ceramic fiber materials into higher ordered ceramic fiber materials such as woven fabrics or the like. The continuous process can also incorporate a post processing chopper that facilitates the formation CNT-infused chopped fiber mats, for example.

In some embodiments, processes of the invention allow for synthesizing a first amount of a first type of carbon nanotube on the ceramic fiber material, in which the first type of carbon nanotube is selected to alter at least one first property of the ceramic fiber material. Subsequently, process of the invention allow for synthesizing a second amount of a second type of carbon nanotube on the ceramic fiber material, in which the second type of carbon nanotube is selected to alter at least one second property of the ceramic fiber material.

In some embodiments, the first amount and second amount of CNTs are different. This can be accompanied by a change in the CNT type or not. Thus, varying the density of CNTs can be used to alter the properties of the original ceramic fiber material, even if the CNT type remains unchanged. CNT type can include CNT length and the number of walls, for example. In some embodiments the first amount and the second amount are the same. If different properties are desirable in this case, along the two different stretches of the spoolable material, then the CNT type can be changed, such as the CNT length. For example, longer CNTs can be useful in electrical/thermal applications, while shorter CNTs can be useful in mechanical strengthening applications.

In light of the aforementioned discussion regarding altering the properties of the ceramic fiber materials, the first type of carbon nanotube and the second type of carbon nanotube can be the same, in some embodiments, while the first type of carbon nanotube and the second type of carbon nanotube can be different, in other embodiments. Likewise, the first property and the second property can be the same, in some embodiments. For example, the EMI shielding property can be the property of interest addressed by the first amount and type of CNTs and the 2nd amount and type of CNTs, but the degree of change in this property can be different, as reflected by differing amounts, and/or types of CNTs employed. Finally, in some embodiments, the first property and the second property can be different. Again this may reflect a change in CNT type. For example the first property can be mechanical strength with shorter CNTs, while the second property can be electrical/thermal properties with longer CNTs. One skilled in the art will recognize the ability to tailor the properties of the ceramic fiber material through the use of different CNT densities, CNT lengths, and the number of walls in the CNTs, such as single-walled, double-walled, and multi-walled, for example.

In some embodiments, processes of the present invention provides synthesizing a first amount of carbon nanotubes on a ceramic fiber material, such that this first amount allows the carbon nanotube-infused ceramic fiber material to exhibit a second group of properties that differ from a first group of properties exhibited by the ceramic fiber material itself That is, selecting an amount that can alter one or more properties of the ceramic fiber material, such as tensile strength. The first group of properties and second group of properties can include at least one of the same properties, thus representing enhancing an already existing property of the ceramic fiber material. In some embodiments, CNT infusion can impart a second group of properties to the carbon nanotube-infused ceramic fiber material that is not included among the first group of properties exhibited by said ceramic fiber material itself.

In some embodiments, a first amount of carbon nanotubes is selected such that the value of at least one property selected from the group consisting of tensile strength, Young's Modulus, shear strength, shear modulus, toughness, compression strength, compression modulus, density, EM wave absorptivity/reflectivity, acoustic transmittance, electrical conductivity, and thermal conductivity of the carbon nanotube-infused carbon fiber material differs from the value of the same property of the carbon fiber material itself.

Tensile strength can include three different measurements: 1) Yield strength which evaluates the stress at which material strain changes from elastic deformation to plastic deformation, causing the material to deform permanently; 2) Ultimate strength which evaluates the maximum stress a material can withstand when subjected to tension, compression or shearing; and 3) Breaking strength which evaluates the stress coordinate on a stress-strain curve at the point of rupture.

Composite shear strength evaluates the stress at which a material fails when a load is applied perpendicular to the fiber direction. Compression strength evaluates the stress at which a material fails when a compressive load is applied.

Multiwalled carbon nanotubes, in particular, have the highest tensile strength of any material yet measured, with a tensile strength of 63 GPa having been achieved. Moreover, theoretical calculations have indicated possible tensile strengths of CNTs of about 300 GPa. Thus, CNT-infused ceramic fiber materials, are expected to have substantially higher ultimate strength compared to the parent ceramic fiber material. As described above, the increase in tensile strength will depend on the exact nature of the CNTs used as well as the density and distribution on the ceramic fiber material. CNT-infused ceramic fiber materials can exhibit a doubling in tensile properties, for example. Exemplary CNT-infused ceramic fiber materials can have as high as three times the shear strength as the parent unfunctionalized ceramic fiber material and as high as 2.5 times the compression strength.

Young's modulus is a measure of the stiffness of an isotropic elastic material. It is defined as the ratio of the uniaxial stress over the uniaxial strain in the range of stress in which Hooke's Law holds. This can be experimentally determined from the slope of a stress-strain curve created during tensile tests conducted on a sample of the material.

Electrical conductivity or specific conductance is a measure of a material's ability to conduct an electric current. CNTs with particular structural parameters such as the degree of twist, which relates to CNT chirality, can be highly conducting, thus exhibiting metallic properties. A recognized system of nomenclature (M. S. Dresselhaus, et al. Science of Fullerenes and Carbon Nanotubes, Academic Press, San Diego, Calif. pp. 756-760, (1996)) has been formalized and is recognized by those skilled in the art with respect to CNT chirality. Thus, for example, CNTs are distinguished from each other by a double index (n,m) where n and m are integers that describe the cut and wrapping of hexagonal graphite so that it makes a tube when it is wrapped onto the surface of a cylinder and the edges are sealed together. When the two indices are the same, m=n, the resultant tube is said to be of the “arm-chair” (or n,n) type, since when the tube is cut perpendicular to the CNT axis only the sides of the hexagons are exposed and their pattern around the periphery of the tube edge resembles the arm and seat of an arm chair repeated n times. Arm-chair CNTs, in particular SWNTs, are metallic, and have extremely high electrical and thermal conductivity. In addition, such SWNTs have-extremely high tensile strength.

In addition to the degree of twist CNT diameter also effects electrical conductivity. As described above, CNT diameter can be controlled by use of controlled size CNT-forming catalyst nanoparticles. CNTs can also be formed as semi-conducting materials. Conductivity in multi-walled CNTs (MWNTs) can be more complex. Interwall reactions within MWNTs can redistribute current over individual tubes non-uniformly. By contrast, there is no change in current across different parts of metallic single-walled nanotubes (SWNTs). Carbon nanotubes also have very high thermal conductivity, comparable to diamond crystal and in-plane graphite sheet.

CNT-infused ceramic fiber materials can benefit from the presence of CNTs not only in the properties described above, but can also provide a lighter material in the process. Thus, such lower density and higher strength materials translates to greater strength to weight ratio. It is understood that modifications which do not substantially affect the activity of the various embodiments of this invention are also included within the definition of the invention provided herein. Accordingly, the following examples are intended to illustrate but not limit the present invention.

### EXAMPLE I

This example shows how a ceramic fiber material can be infused with CNTs in a continuous process to target thermal and electrical conductivity improvements.

In this example, the maximum loading of CNTs on fibers is targeted. Nextel 720 fiber roving with a tex value of 167 (3M, St. Paul, Minn.) is implemented as the ceramic fiber substrate. The individual filaments in this ceramic fiber roving have a diameter of approximately 10-12 μm.

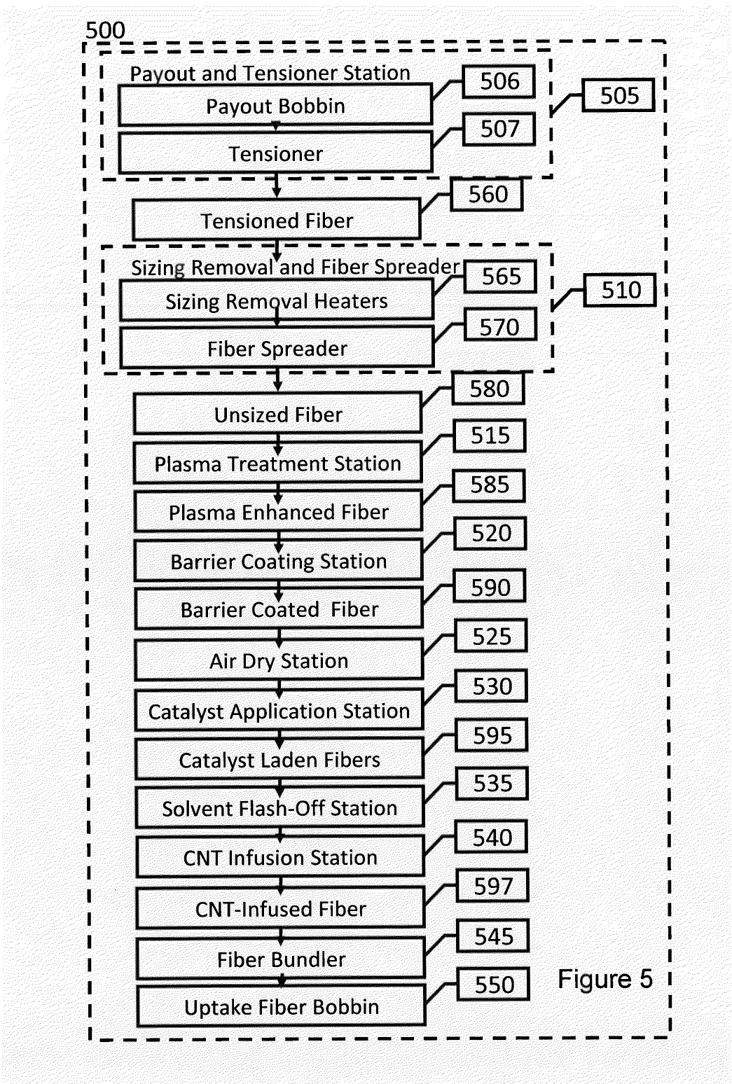

FIG. 5 depicts system 500 for producing CNT-infused fiber in accordance with the illustrative embodiment of the present invention. System 500 includes a ceramic fiber material payout and tensioner station 505, sizing removal and fiber spreader station 510, plasma treatment station 515, barrier coating application station 520, air dry station 525, catalyst application station 530, solvent flash-off station 535, CNT-infusion station 540, fiber bundler station 545, and ceramic fiber material uptake bobbin 550, interrelated as shown.

Payout and tension station 505 includes payout bobbin 506 and tensioner 507. The payout bobbin delivers ceramic fiber material 560 to the process; the fiber is tensioned via tensioner 507. For this example, the ceramic fiber is processed at a linespeed of 2 ft/min.

Fiber material 560 is delivered to sizing removal and fiber spreader station 510 which includes sizing removal heaters 565 and fiber spreader 570. At this station, any “sizing” that is on fiber 560 is removed. Typically, removal is accomplished by burning the sizing off of the fiber. Any of a variety of heating means can be used for this purpose, including, for example, an infrared heater, a muffle furnace, and other non-contact heating processes. Sizing removal can also be accomplished chemically. The fiber spreader separates the individual elements of the fiber. Various techniques and apparatuses can be used to spread fiber, such as pulling the fiber over and under flat, uniform-diameter bars, or over and under variable-diameter bars, or over bars with radially-expanding grooves and a kneading roller, over a vibratory bar, etc. Spreading the fiber enhances the effectiveness of downstream operations, such as plasma application, barrier coating application, and catalyst application, by exposing more fiber surface area.

Multiple sizing removal heaters 565 can be placed throughout the fiber spreader 570 which allows for gradual, simultaneous desizing and spreading of the fibers. Payout and tension station 505 and sizing removal and fiber spreader station 510 are routinely used in the fiber industry; those skilled in the art will be familiar with their design and use.

The temperature and time required for burning off the sizing vary as a function of (1) the sizing material and (2) the commercial source/identity of ceramic fiber material 560. A conventional sizing on a ceramic fiber material can be removed at about 650° C. At this temperature, it can take as long as 15 minutes to ensure a complete burn off of the sizing. Increasing the temperature above this burn temperature can reduce burn-off time. Thermogravimetric analysis is used to determine minimum burn-off temperature for sizing for a particular commercial product.

Depending on the timing required for sizing removal, sizing removal heaters may not necessarily be included in the CNT-infusion process proper; rather, removal can be performed separately (e.g., in parallel, etc.). In this way, an inventory of sizing-free ceramic fiber material can be accumulated and spooled for use in a CNT-infused fiber production line that does not include fiber removal heaters. The sizing-free fiber is then spooled in payout and tension station 505. This production line can be operated at higher speed than one that includes sizing removal.

Unsized fiber 580 is delivered to plasma treatment station 515. For this example, atmospheric plasma treatment is utilized in a ‘downstream’ manner from a distance of 1 mm from the spread ceramic fiber material. The gaseous feedstock is comprised of 100% helium.

Plasma enhanced fiber 585 is delivered to barrier coating station 520. In this illustrative example, a siloxane-based barrier coating solution is employed in a dip coating configuration. The solution is ‘Accuglass T-11 Spin-On Glass’ (Honeywell International Inc., Morristown, N.J.) diluted in isopropyl alcohol by a dilution rate of 40 to 1 by volume. The resulting barrier coating thickness on the ceramic fiber material is approximately 40 nm. The barrier coating can be applied at room temperature in the ambient environment.

Barrier coated ceramic fiber 590 is delivered to air dry station 525 for partial curing of the nanoscale barrier coating. The air dry station sends a stream of heated air across the entire ceramic fiber spread. Temperatures employed can be in the range of 100° C. to about 500° C.

After air drying, barrier coated ceramic fiber 590 is delivered to catalyst application station 530. In this example, an iron oxide-based CNT forming catalyst solution is employed in a dip coating configuration. The solution is ‘EFH-1’ (Ferrotec Corporation, Bedford, N.H.) diluted in hexane by a dilution rate of 200 to 1 by volume. A monolayer of catalyst coating is achieved on the ceramic fiber material. ‘EFH-1’ prior to dilution has a nanoparticle concentration ranging from 3-15% by volume. The iron oxide nanoparticles are of composition Fe₂O₃ and Fe₃O₄ and are approximately 8 nm in diameter.

Catalyst-laden ceramic fiber material 595 is delivered to solvent flash-off station 535. The solvent flash-off station sends a stream of air across the entire ceramic fiber spread. In this example, room temperature air can be employed in order to flash-off all hexane left on the catalyst-laden ceramic fiber material.

After solvent flash-off, catalyst-laden fiber 595 is finally advanced to CNT-infusion station 540. In this example, a rectangular reactor with a 1 foot growth zone is used to employ CVD growth at atmospheric pressure. 98.0% of the total gas flow is inert gas (Nitrogen) and the other 2.0% is the carbon feedstock (acetylene). The growth zone is held at 750° C. For the rectangular reactor mentioned above, 750° C. is a relatively high growth temperature, which allows for the highest growth rates possible.

After CNT-infusion, CNT-infused fiber 597 is re-bundled at fiber bundler station 545. This operation recombines the individual strands of the fiber, effectively reversing the spreading operation that was conducted at station 510.

The bundled, CNT-infused fiber 597 is wound about uptake fiber bobbin 550 for storage. CNT-infused fiber 597 is loaded with CNTs approximately 50 μm in length and is then ready for use in composite materials with enhanced thermal and electrical conductivity.

It is noteworthy that some of the operations described above can be conducted under inert atmosphere or vacuum for environmental isolation. For example, if sizing is being burned off of a ceramic fiber material, the fiber can be environmentally isolated to contain off-gassing and prevent damage from moisture. For convenience, in system 500, environmental isolation is provided for all operations, with the exception of ceramic fiber material payout and tensioning, at the beginning of the production line, and fiber uptake, at the end of the production line.

### EXAMPLE II

This example shows how ceramic fiber material can be infused with CNTs in a continuous process to target improvements in mechanical properties, especially interfacial characteristics such as shear strength. In this case, loading of shorter CNTs on fibers is targeted. In this example, Nextel 610 ceramic fiber roving with a tex value of 333 (3M, St. Paul, Minn.) is implemented as the ceramic fiber substrate. The individual filaments in this ceramic fiber roving have a diameter of approximately 10-12 μm.

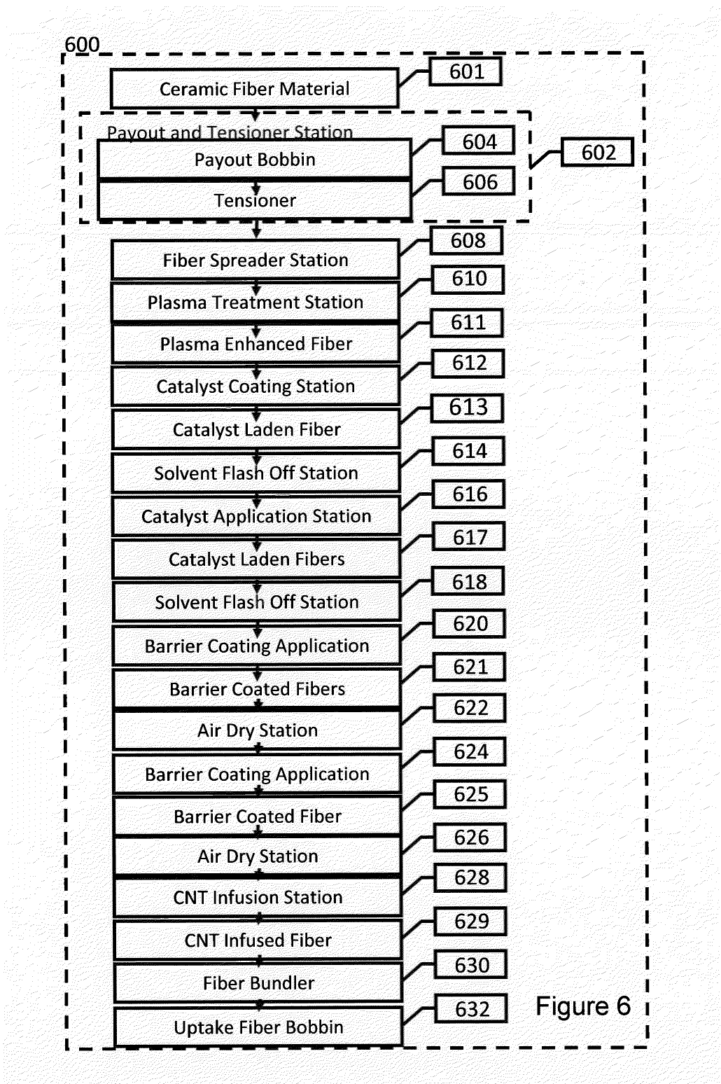

FIG. 6 depicts system 600 for producing CNT-infused fiber in accordance with the illustrative embodiment of the present invention, and involves many of the same stations and processes described in system 500. System 600 includes a ceramic fiber material payout and tensioner station 602, fiber spreader station 608, plasma treatment station 610, catalyst application station 612, solvent flash-off station 614, a second catalyst application station 616, a second solvent flash-off station 618, barrier coating application station 620, air dry station 622, a second barrier coating application station 624, a second air dry station 626, CNT-infusion station 628, fiber bundler station 630, and ceramic fiber material uptake bobbin 632, interrelated as shown.

Payout and tension station 602 includes payout bobbin 604 and tensioner 606. The payout bobbin delivers ceramic fiber material 601 to the process; the fiber is tensioned via tensioner 606. For this example, the ceramic fiber is processed at a linespeed of 2 ft/min.

Fiber material 601 is delivered to fiber spreader station 608. As this fiber is manufactured without sizing, a sizing removal process is not incorporated as part of fiber spreader station 608. The fiber spreader separates the individual elements of the fiber in a similar manner as described in fiber spreader 570.

Fiber material 601 is delivered to plasma treatment station 610. For this example, atmospheric plasma treatment is utilized in a ‘downstream’ manner from a distance of 12 mm from the spread carbon fiber material. The gaseous feedstock is comprised of oxygen in the amount of 1.1% of the total inert gas flow (helium). Controlling the oxygen content on the surface of carbon fiber material is an effective way of enhancing the adherence of subsequent coatings, and is therefore desirable for enhancing mechanical properties of a ceramic fiber composite.

Plasma enhanced fiber 611 is delivered to catalyst application station 612. In this example, an iron oxide based CNT forming catalyst solution is employed in a dip coating configuration. The solution is ‘EFH-1’ (Ferrotec Corporation, Bedford, N.H.) diluted in hexane by a dilution rate of 200 to 1 by volume. A monolayer of catalyst coating is achieved on the ceramic fiber material. ‘EFH-1’ prior to dilution has a nanoparticle concentration ranging from 3-15% by volume. The iron oxide nanoparticles are of composition Fe₂O₃ and Fe₃O₄ and are approximately 8 nm in diameter.

Catalyst-laden carbon fiber material 613 is delivered to solvent flash-off station 614. The solvent flash-off station sends a stream of air across the entire ceramic fiber spread. In this example, room temperature air can be employed in order to flash-off all hexane left on the catalyst-laden ceramic fiber material.

After solvent flash-off, catalyst laden fiber 613 is delivered to catalyst application station 616, which is identical to catalyst application station 612. The solution is ‘EFH-1’ diluted in hexane by a dilution rate of 800 to 1 by volume. For this example, a configuration which includes multiple catalyst application stations is utilized to optimize the coverage of the catalyst on the plasma enhanced fiber 611.

Catalyst-laden ceramic fiber material 617 is delivered to solvent flash-off station 918, which is identical to solvent flash-off station 614.

After solvent flash-off, catalyst-laden ceramic fiber material 617 is delivered to barrier coating application station 620. In this example, a siloxane-based barrier coating solution is employed in a dip coating configuration. The solution is ‘Accuglass T-11 Spin-On Glass’ (Honeywell International Inc., Morristown, N.J.) diluted in isopropyl alcohol by a dilution rate of 40 to 1 by volume. The resulting barrier coating thickness on the ceramic fiber material is approximately 40 nm. The barrier coating can be applied at room temperature in the ambient environment.

Barrier coated ceramic fiber 621 is delivered to air dry station 622 for partial curing of the barrier coating. The air dry station sends a stream of heated air across the entire ceramic fiber spread. Temperatures employed can be in the range of 100° C. to about 500° C.

After air drying, barrier coated ceramic fiber 621 is delivered to barrier coating application station 624, which is identical to barrier coating application station 520. The solution is ‘Accuglass T-11 Spin-On Glass’ diluted in isopropyl alcohol by a dilution rate of 120 to 1 by volume. For this example, a configuration which includes multiple barrier coating application stations is utilized to optimize the coverage of the barrier coating on the catalyst-laden fiber 617.

Barrier coated ceramic fiber 625 is delivered to air dry station 626 for partial curing of the barrier coating, and is identical to air dry station 622.

After air drying, barrier coated ceramic fiber 625 is finally advanced to CNT-infusion station 628. In this example, a rectangular reactor with a 12 inch growth zone is used to employ CVD growth at atmospheric pressure. 97.75% of the total gas flow is inert gas (Nitrogen) and the other 2.25% is the carbon feedstock (acetylene). The growth zone is held at 650° C. For the rectangular reactor mentioned above, 650° C. is a relatively low growth temperature, which allows for the control of shorter CNT growth.

After CNT-infusion, CNT-infused fiber 629 is re-bundled at fiber bundler 630. This operation recombines the individual strands of the fiber, effectively reversing the spreading operation that was conducted at station 608.

The bundled, CNT-infused fiber 631 is wound about uptake fiber bobbin 632 for storage. CNT-infused fiber 629 is loaded with CNTs approximately 5 μm in length and is then ready for use in composite materials with enhanced mechanical properties.

In this example, the carbon fiber material passes through catalyst application stations 612 and 616 prior to barrier coating application stations 620 and 624. This ordering of coatings is in the ‘reverse’ order as illustrated in Example I, which can improve anchoring of the CNTs to the ceramic fiber substrate. During the CNT growth process, the barrier coating layer is lifted off of the substrate by the CNTs, which allows for more direct contact with the ceramic fiber material (via catalyst NP interface). Because increases in mechanical properties, and not thermal/electrical properties, are being targeted, a ‘reverse’ order coating configuration is desirable.

It is noteworthy that some of the operations described above can be conducted under inert atmosphere or vacuum for environmental isolation. For convenience, in system 900, environmental isolation is provided for all operations, with the exception of ceramic fiber material payout and tensioning, at the beginning of the production line, and fiber uptake, at the end of the production line.

### EXAMPLE III

This example demonstrates the CNT-infusion of ceramic fiber in a continuous process for applications requiring improved tensile strength, where the system is interfaced with subsequent resin incorporation and winding process. In this case, a length CNT greater than 10 microns is desirable.

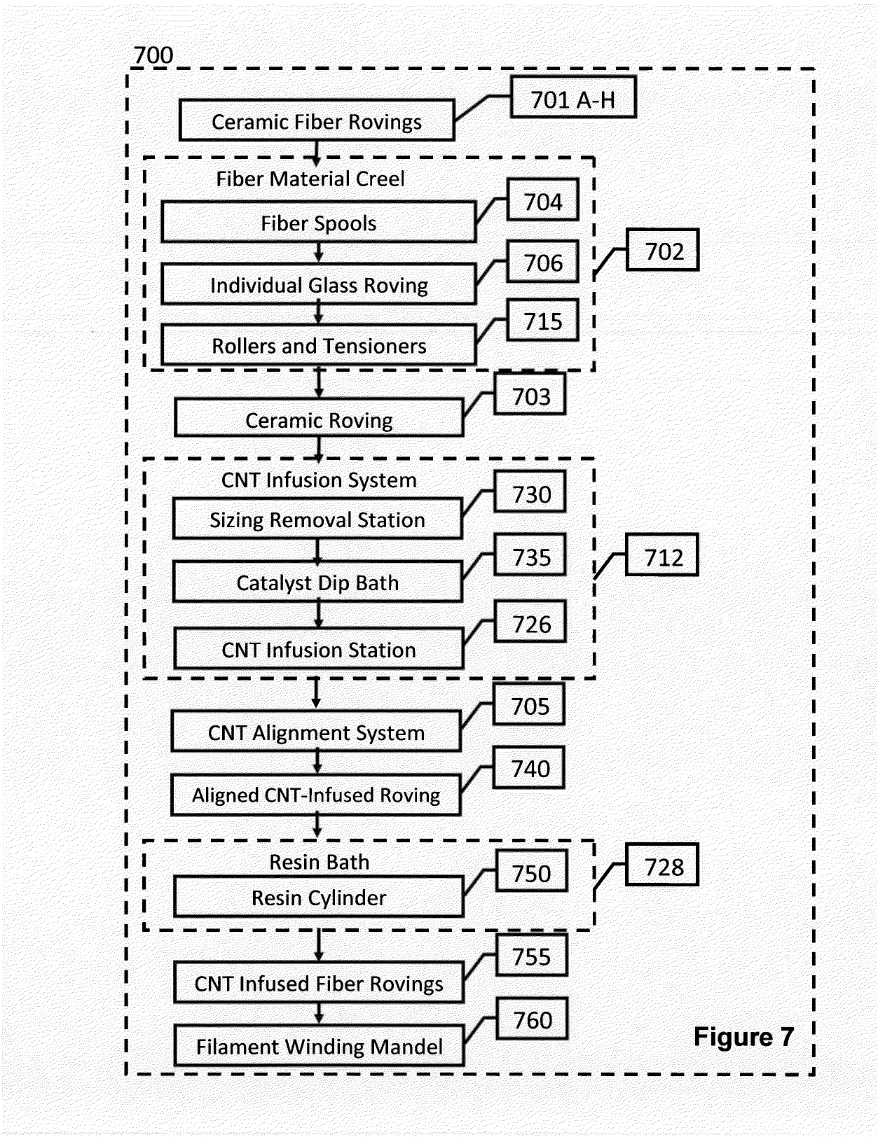

FIG. 7 depicts a further illustrative embodiment of the invention wherein CNT-infused fiber is created as a sub-operation of a filament winding process being conducted via filament winding system 700.

System 700 comprises ceramic fiber material creel 702, carbon nanotube infusion system 712, CNT alignment system 705, resin bath 728, and filament winding mandrel 760, interrelated as shown. The various elements of system 700, with the exception of carbon nanotube infusion system 712 and CNT alignment system 705, are present in conventional filament winding processes. The main element of the process and system depicted in FIG. 7 is the carbon nanotube infusion system 712, which includes (optional) sizing-removal station 710, and CNT-infusion station 726.

Fiber creel 702 includes a plurality of spools 704 of ceramic fiber material comprising one roving per spool 701A through 701H. The untwisted group of ceramic fiber rovings 701A through 701H is referred to collectively as “ceramic roving 703.”

Creel 702 holds spools 704 in a horizontal orientation. The ceramic fiber roving from each spool 706 moves through small, appropriately situated rollers and tensioners 715 that planarize and align the direction of the fibers in a parallel arrangement as they move out of creel 702 and toward carbon nanotube infusion system 712 at a tension of 1-5 lbs. In this example, fibers are pulled from the creel at a linespeed of 5 ft/min.

It is understood that in some alternative embodiments, the spooled ceramic fiber material that is used in system 700 is already a CNT-infused ceramic fiber material (i.e., produced via system 500). In such embodiments, system 700 is operated without nanotube infusion system 712.

In carbon nanotube infusion system 712, roving 703 sizing is removed, nanotube-forming catalyst is applied, and the roving is exposed to CNT growth conditions via the CVD growth system.

Sizing removal station 730 exposes roving 703 to elevated temperatures in an inert (nitrogen) atmosphere. In this example, roving 703 is exposed to 550° C. temperatures for a residence time of 30 seconds.

In this illustrative example, the catalyst solution is applied via a dip process, such as by roving 703 through a dip bath 735. In this example, a catalyst solution consisting of a volumetric ratio of 1 part ferrofluid nanoparticle solution and 200 parts hexane is used. At the process linespeed for CNT-infused fiber targeted at improving tensile strength, the fiber will remain in the dip bath for 25 seconds. The catalyst can be applied at room temperature in the ambient environment with neither vacuum nor an inert atmosphere required.

Catalyst laden roving 703 is then advanced to the CNT Infusion station 726 consisting of a pre-growth cool inert gas purge zone, a CNT growth zone, and a post-growth gas purge zone. Room temperature nitrogen gas is introduced to the pre-growth purge zone in order to cool exiting gas from the CNT growth zone as described above. The exiting gas is cooled to below 250° C. via the rapid nitrogen purge to prevent fiber oxidation. Fibers enter the CNT growth zone where elevated temperatures heat a mixture of 99% mass flow inert gas (nitrogen) and 1% mass flow carbon containing feedstock gas (acetylene) which is introduced centrally via a gas manifold. In this example, the system length is 5 feet and the temperature in the CNT growth zone is 650° C. Catalyst laden fibers are exposed to the CNT growth environment for 60 seconds in this example, resulting in 15 micron long with a 4% volume percentage of CNTs infused to the ceramic fiber surface. The CNT-Infused ceramic fibers finally pass through the post-growth purge zone which at 250° C. cools the fiber as well as the exiting gas to prevent oxidation to the fiber surface and CNTs.

CNT-infused roving 703 is then passed through the CNT alignment system 705, where a series of dies are used to mechanically align the CNTs' axis in the direction of each roving 701A-H of roving 703. Tapered dies ending with a 0.125 inch diameter opening is used to aid in the alignment of the CNTs.

After passing through CNT alignment system 705, aligned CNT-infused roving 740 is delivered to resin bath 728. The resin bath contains resin for the production of a composite material comprising the CNT-infused fiber and the resin. This resin can include commercially-available resin matrices such as polyester (e.g., orthophthalic polyesters, etc.), improved polyester (e.g., isophthalic polyesters, etc.), epoxy, and vinyl ester.

Resin bath 728 can be implemented in a variety of ways, two of which are described below. First, resin bath 728 can be implemented as a doctor blade roller bath wherein a polished rotating cylinder (e.g., cylinder 750) that is disposed in the bath picks up resin as it turns. The doctor bar (not depicted in FIG. 7) presses against the cylinder to obtain a precise resin film thickness on cylinder 750 and pushes excess resin back into the bath. As aligned CNT-infused ceramic fiber roving 740 is pulled over the top of cylinder 750, it contacts the resin film and wets out. Alternatively, resin bath 728 is used as an immersion bath wherein aligned CNT-infused ceramic fiber roving 740 is submerged into the resin and then pulled through a set of wipers or rollers that remove excess resin.

After leaving resin bath 728, resin-wetted, CNT-infused fiber rovings 755 are passed through various rings, eyelets and, typically, a multi-pin “comb” (not depicted) that is disposed behind a delivery head (not depicted). The comb keeps the CNT-infused ceramic fiber rovings 755 separate until they are brought together in a single combined band on rotating mandrel 760. The mandrel acts as a mold for a structure requiring composites material with improved tensile strength.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other processes, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A system for the continuous production of carbon nanotubes on a ceramic fiber material comprising:
a catalyst application station comprising a colloidal solution of CNT growth catalyst nanoparticles; and
a CNT growth station comprising at least one purge zone and a growth chamber; said growth station adapted for CNT growth on the ceramic fiber material by continuously feeding the ceramic fiber material through the growth station;
said system being capable of reel to reel growth of CNTs on the ceramic fiber material continuously by providing a payout bobbin and an uptake bobbin; said ceramic fiber material being provided in spoolable form.

2. The system of claim 1, wherein said CNT growth station is open to, but separated from the outside environment by the use of an inert gas flow.

3. The system of claim 1 further comprising a payout and tensioner station.

4. The system of claim 1 further comprising a fiber spreading station.

5. The system of claim 1 further comprising a plasma station adapted to roughen the surface of the ceramic fiber material.

6. The system of claim 1 further comprising a barrier coating station adapted to conformally deposit a barrier coating on said ceramic fiber material; said barrier coating having CNT growth catalyst embedded therein.

7. The system of claim 5, wherein the catalyst application station and barrier coating station are combined.

8. The system of claim 5, wherein said barrier coating station comprises at least one of spin-on glass, an alumina, a silane, an alkoxysilane, and a liquid ceramic.

9. The system of claim 1 further comprising a fiber sizing removal station.

10. The system of claim 1 further comprising a resin application station downstream of said CNT growth station.

11. The system of claim 1 which is capable of operating speeds in a range from between about 0.5 ft/min to about 36 ft/min.

12. The system of claim 1 further comprising a controller station; said controller station capable of controlling at least one of linespeed, an inert gas flow rate, a carbon feedstock flowrate, temperature in the CNT growth chamber, temperature of the inert gas, and temperature of the carbon feedstock gas.

13. The system of claim 1, wherein a material residence time in the growth chamber between about 5 to about 30 seconds produces CNTs having a length between about 1 micron to about 10 microns.

14. The system of claim 1, wherein a material residence time in the growth chamber of about 30 to about 180 seconds produces CNTs having a length between about 10 microns to about 100 microns.

15. The system of claim 1, wherein a material residence time in the growth chamber of about 180 to about 300 seconds produces CNTs having a length between about 100 microns to about 500 microns.
